(19) United States
(12) Patent Application Publication
(10) Pub. No.: US 2017/0341236 A1
(43) Pub. Date: Nov. 30, 2017

(54) INTEGRATED ROBOTIC SYSTEM AND METHOD FOR AUTONOMOUS VEHICLE MAINTENANCE

(71) Applicant: General Electric Company, Schenectady, NY (US)

(72) Inventors: Romano Patrick, Atlanta, GA (US); Shiraj Sen, Niskayuna, NY (US); Arpit Jain, Niskayuna, NY (US); Huan Tan, Niskayuna, NY (US); Yonatan Gefen, Niskayuna, NY (US); Shuai Li, Niskayuna, NY (US); Shubao Liu, College Park, MD (US); Pramod Sharma, Seattle, WA (US); Balajee Kannan, Niskayuna, NY (US); Viktor Holovashchenko, Niskayuna, NY (US); Douglas Forman, Niskayuna, NY (US); John Michael Lizzi, Niskayuna, NY (US); Charles Burton Theurer, Alplaus, NY (US); Omar Al Assad, Niskayuna, NY (US); Ghulam Ali Baloch, Niskayuna, NY (US); Frederick Wheeler, Niskayuna, NY (US)

(21) Appl. No.: 15/292,605

(22) Filed: Oct. 13, 2016

Related U.S. Application Data
(60) Provisional application No. 62/342,510, filed on May 27, 2016.

(51) Int. Cl. B25J 9/16; B25J 13/08; B61G 7/04; G05D 1/02

(52) U.S. Cl. CPC B25J 9/1697; G05D 1/0251; B25J 13/084; B61G 7/04; Y10S 901/01

(57) ABSTRACT

A robotic system includes a controller configured to obtain image data from one or more optical sensors and to determine one or more of a location and/or pose of a vehicle component based on the image data. The controller also is configured to determine a model of an external environment of the robotic system based on the image data and to determine tasks to be performed by components of the robotic system to perform maintenance on the vehicle component. The controller also is configured to assign the tasks to the components of the robotic system and to communicate control signals to the components of the robotic system to autonomously control the robotic system to perform the maintenance on the vehicle component.

### CROSS-REFERENCE TO RELATED APPLICATIONS

This application claims priority to U.S. Provisional Application No. 62/342,510, filed 27 May 2016, the entire disclosure of which is incorporated herein by reference.

### FIELD

The subject matter described herein relates to systems and methods for autonomously maintaining vehicles.

### BACKGROUND

The challenges in the modern vehicle yards are vast and diverse. Classification yards, or hump yards, play an important role as consolidation nodes in vehicle freight networks. At classification yards, inbound vehicle systems (e.g., trains) are disassembled and the cargo-carrying vehicles (e.g., railcars) are sorted by next common destination (or block). The efficiency of the yards in part drives the efficiency of the entire transportation network.

The hump yard is generally divided into three main areas: the receiving yard, where inbound vehicle systems arrive and are prepared for sorting; the class yard, where cargo-carrying vehicles in the vehicle systems are sorted into blocks; and the departure yard, where blocks of vehicles are assembled into outbound vehicle systems, inspected, and then depart.

Current solutions for field service operations are labor-intensive, dangerous, and limited by the operational capabilities of humans being able to make critical decisions in the presence of incomplete or incorrect information. Furthermore, efficient system level-operations require integrated system wide solutions, more than just point solutions to key challenges. The nature of these missions dictates that the tasks and environments cannot always be fully anticipated or specified at the design time, yet an autonomous solution may need the essential capabilities and tools to carry out the mission even if it encounters situations that were not expected.

Solutions for typical vehicle yard problems, such as brake bleeding, brake line lacing, coupling cars, etc., can require combining mobility, perception, and manipulation toward a tightly integrated autonomous solution. When placing robots in an outdoor environment, technical challenges largely increase, but field robotic application benefits both technically and economically. One key challenge in yard operation is that of bleeding brakes on inbound cars in the receiving yard. Railcars have pneumatic breaking systems that work on the concept of a pressure differential. The size of the brake lever is significantly small compared to the size of the environment and the cargo-carrying vehicles. Additionally, there are lots of variations on the shape, location, and the material of the brake levers. Coupled with that is the inherent uncertainty in the environment; every day, vehicles are placed at different locations, and the spaces between cars are very narrow and unstructured. As a result, an autonomous solution for maintenance (e.g., brake maintenance) of the vehicles presents a variety of difficult challenges.

### BRIEF DESCRIPTION

In one embodiment, a robotic system includes a controller configured to obtain image data from one or more optical sensors and to determine one or more of a location and/or pose of a vehicle component based on the image data. The controller also is configured to determine a model of an external environment of the robotic system based on the image data and to determine tasks to be performed by components of the robotic system to perform maintenance on the vehicle component. The controller also is configured to assign the tasks to the components of the robotic system and to communicate control signals to the components of the robotic system to autonomously control the robotic system to perform the maintenance on the vehicle component.

In one embodiment, a method includes obtaining image data from one or more optical sensors, determining one or more of a location or pose of a vehicle component based on the image data, determining a model of an external environment of the robotic system based on the image data, determining tasks to be performed by components of the robotic system to perform maintenance on the vehicle component, assigning the tasks to the components of the robotic system, and communicating control signals to the components of the robotic system to autonomously control the robotic system to perform the maintenance on the vehicle component.

In one embodiment, a robotic system includes one or more optical sensors configured to generate image data representative of an external environment and a controller configured to obtain the image data and to determine one or more of a location or pose of a vehicle component based on the image data. The controller also can be configured to determine tasks to be performed by components of the robotic system to perform maintenance on the vehicle component and to assign the tasks to the components of the robotic system based on the image data and based on a model of the external environment. The controller can be configured to communicate control signals to the components of the robotic system to autonomously control the robotic system to perform the maintenance on the vehicle component.

### BRIEF DESCRIPTION OF THE DRAWINGS

The present inventive subject matter will be better understood from reading the following description of non-limiting embodiments, with reference to the attached drawings, wherein below:

FIG. 1 illustrates one embodiment of a robotic system;

FIG. 2 illustrates a control architecture used by the robotic system shown in FIG. 1 to move toward, grasp, and actuate a brake lever or rod according to one embodiment;

FIG. 3 illustrates 2D image data of a manipulator arm shown in FIG. 1 near a vehicle;

FIG. 4 illustrates one example of a model of an external environment around the manipulator arm; and

FIG. 5 illustrates a flowchart of one embodiment of a method for autonomous control of a robotic system for vehicle maintenance.

### DETAILED DESCRIPTION

One or more embodiments of the inventive subject matter described herein provide robotic systems and methods that provide a large form factor mobile robot with an industrial manipulator arm to effectively detect, identify, and subsequently manipulate components to perform maintenance on vehicles, which can include inspection and/or repair of the vehicles. While the description herein focuses on manipulating brake levers of vehicles (e.g., rail vehicles) in order to bleed air brakes of the vehicles, not all maintenance operations performed by the robotic systems or using the methods described herein are limited to brake bleeding. One or more embodiments of the robotic systems and methods described herein can be used to perform other maintenance operations on vehicles, such as obtaining information from vehicles (e.g., AEI tag reading), inspecting vehicles (e.g., inspecting couplers between vehicles), air hose lacing, etc.

The robotic system autonomously navigates within a route corridor along the length of a vehicle system, moving from vehicle to vehicle within the vehicle system. An initial “coarse” estimate of a location of a brake rod or lever on a selected or designated vehicle in the vehicle system is provided to or obtained by the robotic system. This coarse estimate can be derived or extracted from a database or other memory structure that represents the vehicles present in the corridor (e.g., the vehicles on the same segment of a route within the yard). The robotic system moves through or along the vehicles and locates the brake lever rods on the side of one or more, or each, vehicle. The robotic system positions itself next to a brake rod to then actuate a brake release mechanism (e.g., to initiate brake bleeding) by manipulating the brake lever rod.

During autonomous navigation, the robotic system maintains a distance of separation (e.g., about four inches or ten centimeters) from the plane of the vehicle while moving forward toward the vehicle. In order to ensure real-time brake rod detection and subsequent estimation of the brake rod location, a two-stage detection strategy is utilized. Once the robotic system has moved to a location near to the brake rod, an extremely fast two-dimensional (2-D) vision-based search is performed by the robotic system to determine and/or confirm a coarse location of the brake rod. The second stage of the detection strategy involves building a dense model for template-based shape matching (e.g., of the brake rod) to identify the exact location and pose of the break rod. The robotic system can move to approach the brake rod as necessary to have the brake rod within reach of the robotic arm of the robotic system. Once the rod is within reach of the robotic arm, the robotic system uses the arm to manipulate and actuate the rod.

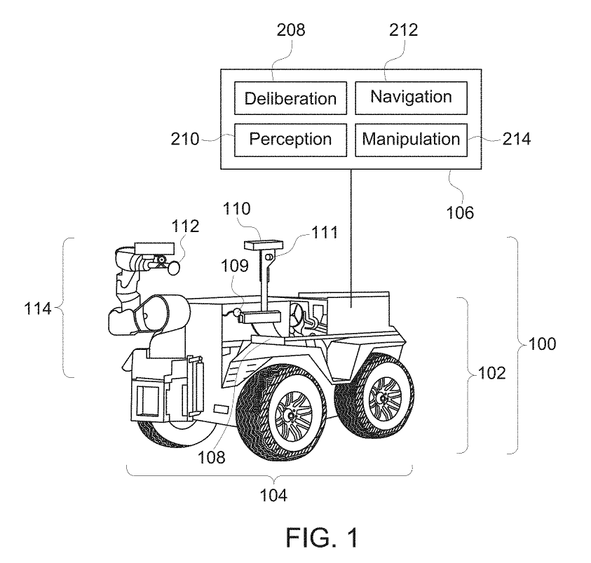

FIG. 1 illustrates one embodiment of a robotic system 100. The robotic system 100 may be used to autonomously move toward, grasp, and actuate (e.g., move) a brake lever or rod on a vehicle in order to change a state of a brake system of the vehicle. For example, the robotic system 100 may autonomously move toward, grasp, and move a brake rod of an air brake system on a rail car in order to bleed air out of the brake system. The robotic system 100 includes a robotic vehicle 102 having a propulsion system 104 that operates to move the robotic system 100. The propulsion system 104 may include one or more motors, power sources (e.g., batteries, alternators, generators, etc.), or the like, for moving the robotic system 100. A controller 106 of the robotic system 100 includes hardware circuitry that includes and/or is connected with one or more processors (e.g., microprocessors, field programmable gate arrays, and/or integrated circuits) that direct operations of the robotic system 100.

The robotic system 100 also includes several sensors 108, 109, 110, 111, 112 that measure or detect various conditions used by the robotic system 100 to move toward, grasp, and actuate brake levers. The sensors 108-111 are optical sensors, such as cameras, infrared projectors and/or detectors. While four optical sensors 108, 110 are shown, alternatively, the robotic system 100 may have a single optical sensor, less than four optical sensors, or more than four optical sensors. In one embodiment, the sensors 109, 111 are RGB cameras and the sensors 110, 112 are structured-light three-dimensional (3-D) cameras, but alternatively may be another type of camera.

The sensor 112 is a touch sensor that detects when a manipulator arm 114 of the robotic system 100 contacts or otherwise engages a surface or object. The touch sensor 112 may be one or more of a variety of touch-sensitive devices, such as a switch (e.g., that is closed upon touch or contact), a capacitive element (e.g., that is charged or discharged upon touch or contact), or the like.

The manipulator arm 114 is an elongated body of the robotic system 100 that can move in a variety of directions, grasp, and pull and/or push a brake rod. The controller 106 may be operably connected with the propulsion system 104 and the manipulator arm 114 to control movement of the robotic system 100 and/or the arm 114, such as by one or more wired and/or wireless connections. The controller 106 may be operably connected with the sensors 108-112 to receive data obtained, detected, or measured by the sensors 108-112.

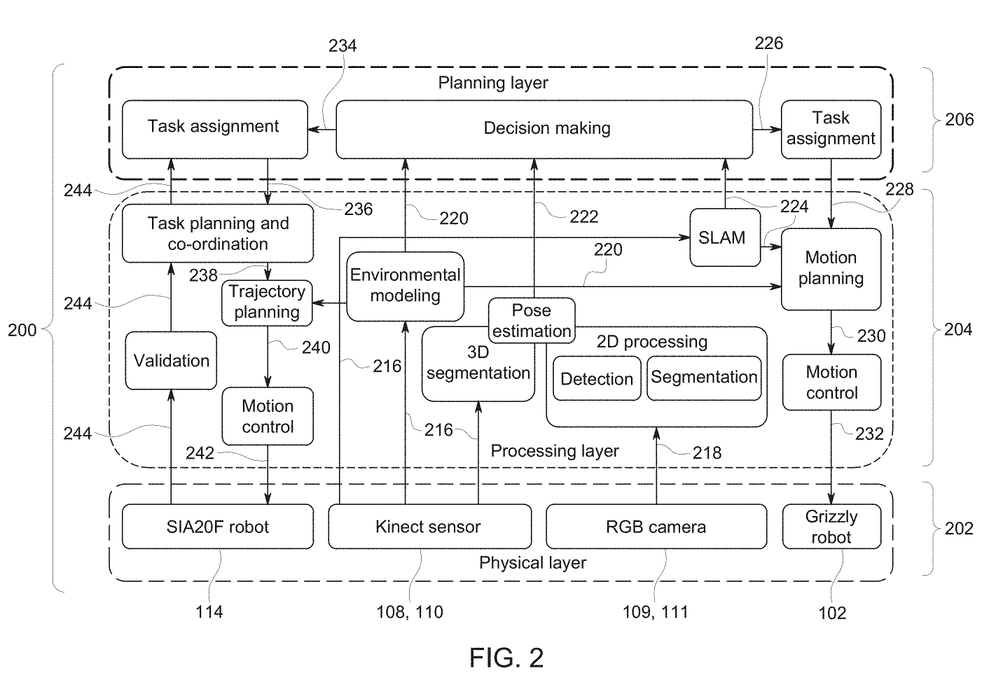

FIG. 2 illustrates a control architecture 200 used by the robotic system 100 to move toward, grasp, and actuate a brake lever or rod according to one embodiment. The architecture 200 may represent the operations performed by various components of the robotic system 100. The architecture 200 is composed of three layers: a physical layer 202, a processing layer 204, and a planning layer 206. The physical layer 202 includes the robotic vehicle 102 (including the propulsion system 104, shown as “Grizzly Robot” in FIG. 2), the sensors 108-112 (e.g., the “RGB Camera” as the sensors 109, 111 and the “Kinect Sensor” as the sensors 108, 110 in FIG. 2), and the manipulator arm 114 (e.g., the “SIA20F Robot” in FIG. 2).

The processing layer 204 is embodied in the controller 106, and dictates operation of the robotic system 100. The processing layer 204 performs or determines how the robotic system 100 will move or operate to perform various tasks in a safe and/or efficient manner. The operations determined by the processing layer 204 can be referred to as modules. These modules can represent the algorithms or software used by the processing layer 204 to determine how to perform the operations of the robotic system 100, or optionally represent the hardware circuitry of the controller 106 that determines how to perform the operations of the robotic system 100. The modules are shown in FIG. 1 inside the controller 106.

The modules of the processing layer 204 include a deliberation module 208, a perception module 210, a navigation module 212, and a manipulation module 214. The deliberation module 208 is responsible for planning and coordinating all behaviors or movements of the robotic system 100. The deliberation module 208 can determine how the various physical components of the robotic system 100 move in order to avoid collision with each other, with vehicles, with human operators, etc., while still moving to perform various tasks. The deliberation module 208 receives processed information from one or more of the sensors 108-112 and determines when the robotic vehicle 102 and/or manipulator arm 114 are to move based on the information received or otherwise provided by the sensors 108-112.

The perception module 210 receives data provided by the sensors 108-112 and processes this data to determine the relative positions and/or orientations of components of the vehicles. For example, the perception module 210 may receive image data provided by the sensors 108-111 and determine the location of a brake lever relative to the robotic system 100, as well as the orientation (e.g., pose) of the brake lever. At least some of the operations performed by the perception module 210 are shown in FIG. 2. For example, the perception module 210 can perform 2D processing of image data provided by the sensors 109, 111. This 2D processing can involve receiving image data from the sensors 109, 111 (“Detection” in FIG. 2) and examining the image data to identify components or objects external to the robotic system 100 (e.g., components of vehicles, “Segmentation” in FIG. 2). The perception module 210 can perform 3D processing of image data provided by the sensors 108, 110. This 3D processing can involve identifying different portions or segments of the objects identified via the 2D processing (“3D Segmentation” in FIG. 2). From the 2D and 3D image processing, the perception module 210 may determine the orientation of one or more components of the vehicle, such as a pose of a brake lever (“Pose estimation” in FIG. 2).

The navigation module 212 determines the control signals generated by the controller 106 and communicated to the propulsion system 104 to direct how the propulsion system 104 moves the robotic system 100. The navigation module 212 may use a real-time appearance-based mapping (RTAB-Map) algorithm (or a variant thereof) to plan how to move the robotic system 100. Alternatively, another algorithm may be used.

The navigation module 212 may use modeling of the environment around the robotic system 100 to determine information used for planning motion of the robotic system 100. Because the actual environment may not be previously known and/or may dynamically change (e.g., due to moving human operators, moving vehicles, errors or discrepancies between designated and actual locations of objects, etc.), a model of the environment may be determined by the controller 106 and used by the navigation module 212 to determine where and how to move the robotic system 100 while avoiding collisions. The manipulation module 214 determines how to control the manipulator arm 114 to engage (e.g., touch, grasp, etc.) one or more components of a vehicle, such as a brake lever.

In the planning layer 206, the information obtained by the sensors 108-112 and state information of the robotic system 100 are collected from the lower layers 202, 204. According to the requirements of a task to be completed or performed by the robotic system 100, the controller 106 (e.g., within the planning layer 206) will make different decisions based on the current task-relevant situation being performed or the next task to be performed by the robotic system 100. A state machine can tie the layers 202, 204, 206 together and transfer signals between the navigation module 212 and the perception module 210, and then to the manipulation module 214. If there is an emergency stop signal generated or there is error information reported by one or more of the modules, the controller 106 may responsively trigger safety primitives such as stopping movement of the robotic system 100 to prevent damage to the robotic system 100 and/or surrounding environment.

As shown in FIG. 2, the processing layer 204 of the controller 106 may receive image data 216 from the sensors 108, 110. This image data 216 can represent or include 3D image data representative of the environment that is external to the robotic system 100. This image data 216 is used by the processing layer 204 of the controller 106 to generate a model or other representation of the environment external to the robotic system 100 (“Environmental Modeling” in FIG. 2) in one embodiment. The environmental modeling can resent locations of objects relative to the robotic system 100, grades of the surface on which the robotic vehicle 102 is traveling, obstructions in the moving path of the robotic system 100, etc. The 3D image data 216 optionally can be examined using real-time simultaneous localization and mapping (SLAM) to model the environment around the robotic system 100.

The processing layer 204 can receive the image data 216 from the sensors 108, 110 and/or image data 218 from the sensors 109, 111. The image data 218 can represent or include 2D image data representative of the environment that is external to the robotic system 100. The 2D image data 218 can be used by the processing layer 204 of the controller 106 to identify objects that may be components of a vehicle, such as a brake lever (“2D Processing” in FIG. 2). This identification may be performed by detecting potential objects (“Detection” in FIG. 2) based on the shapes and/or sizes of the objects in the 2D image data and segmenting the objects into smaller components (“Segmentation” in FIG. 2). The 3D image data 216 can be used by the processing layer 204 to further examine these objects and determine whether the objects identified in the 2D image data 218 are or are not designated objects, or objects of interest, such as a component to be grasped, touched, moved, or otherwise actuated by the robotic system 100 to achieve or perform a designated task (e.g., moving a brake lever to bleed air brakes of a vehicle). In one embodiment, the processing layer 204 of the controller 106 uses the 3D segmented image data and the 2D segmented image data to determine an orientation (e.g., pose) of an object of interest (“Pose estimation” in FIG. 2). For example, based on the segments of a brake lever in the 3D and 2D image data, the processing layer 204 can determine a pose of the brake lever.

The planning layer 206 of the controller 106 can receive at least some of this information to determine how to operate the robotic system 100. For example, the planning layer 206 can receive a model 220 of the environment surrounding the robotic system 100 from the processing layer 204, an estimated or determined pose 222 of an object-of-interest (e.g., a brake lever) from the processing layer 204, and/or a location 224 of the robotic system 100 within the environment that is modeled from the processing layer 204.

In order to move in the environment, the robotic system 100 generates the model 220 of the external environment in order to understand the environment. In one embodiment, the robotic system 100 may be limited to moving only along the length of a vehicle system formed from multiple vehicles (e.g., a train typically about 100 rail cars long), and does not need to move longer distance. As a result, more global planning of movements of the robotic system 100 may not be needed or generated. For local movement planning and movement, the planning layer 206 can use a structured light-based SLAM algorithm, such as real-time appearance-based mapping (RTAB-Map), that is based on an incremental appearance-based loop closure detector. Using RTAB-Map, the planning layer 206 of the controller 106 can determine the location of the robotic system 100 relative to other objects in the environment, which can then be used to close a motion control loop and prevent collisions between the robotic system 100 and other objects. The point cloud data provided as the 3D image data can be used recognize the surfaces or planes of the vehicles. This information is used to keep the robotic system 100 away from the vehicles and maintain a pre-defined distance of separation from the vehicles.

In one embodiment, the model 220 is a grid-based representation of the environment around the robotic system 100. The 3D image data collected using the sensors 108, 110 can include point cloud data provided by one or more structured light sensors. The point cloud data points are processed and grouped into a grid.

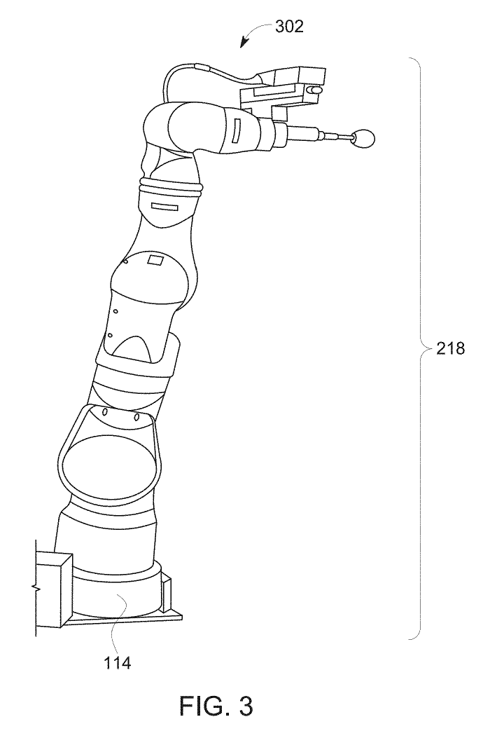

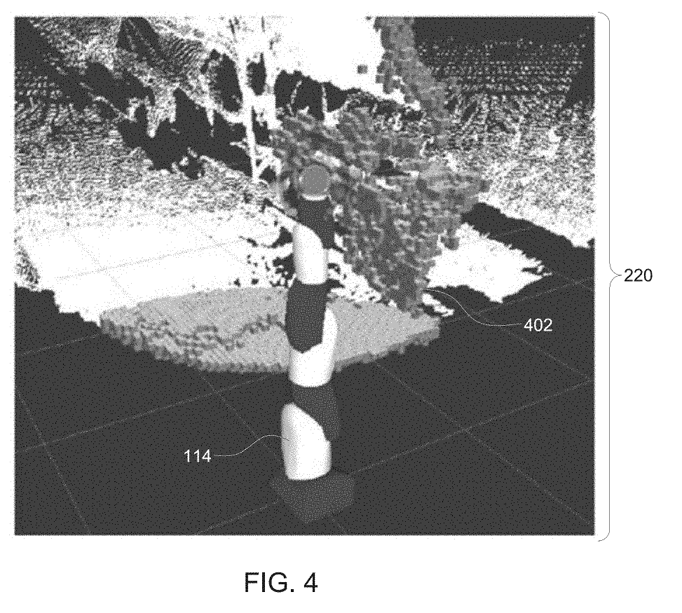

FIG. 3 illustrates 2D image data 218 of the manipulator arm 114 near a vehicle 302. FIG. 4 illustrates one example of the model 220 of the environment around the manipulator arm 114. The model 220 may be created by using grid cubes 402 with designated sizes (e.g., ten centimeters by ten centimeters by ten centimeters to represent different portions of the objects detected using the 2D and/or 3D image data 218, 216. In order to reduce the time needed to generate the model 220, only a designated volume around the arm 114 may be modeled (e.g., the area within a sphere having a radius of 2.5 meters or another distance).

Returning to the description of the control architecture 200 shown in FIG. 2, the planning layer 206 of the controller 106 determines how to operate (e.g., move) the robotic system 100 based on the environmental model of the surroundings of the robotic system 100. This determination can involve determining tasks to be performed and which components of the robotic system 100 are to perform the tasks. the planning layer 206 can determine tasks to be performed by the robotic vehicle 102 to move the robotic system 100. These tasks can include the distance, direction, and/or speed that the robotic vehicle 102 moves the robotic system 100, the sequence of movements of the robotic vehicle 102, and the like. The planning layer 206 can determine how the robotic system 100 moves in order to avoid collisions between the robotic vehicle 102 and the manipulator arm 114, between the robotic vehicle 102 and the object(s) of interest, and/or between the robotic vehicle 102 and other objects.

The movements and/or sequence of movements determined by the planning layer 206 of the controller 106 may be referred to as movement tasks 226. These movement tasks 226 can dictate the order of different movements, the magnitude (e.g., distance) of the movements, the speed and/or acceleration involved in the movements, etc. The movement tasks 226 can then be assigned to various components of the robotic system 100 (“Task Assignment” in FIG. 2). For example, the planning layer 206 can communicate the tasks movement 226 and the different components that are to perform the movement tasks 226 to the processing layer 204 of the controller 106 as assigned movement tasks 228. The assigned movement tasks 228 can indicate the various movement tasks 226 as well as which component (e.g., the robotic vehicle 102 and/or the manipulator arm 114) is to perform the various movement tasks 226.

The processing layer 204 receives the assigned movement tasks 228 and plans the movement of the robotic system 100 based on the assigned movement tasks 228 (“Motion Planning” in FIG. 2). This planning can include determining which component of the robotic vehicle 102 is to perform an assigned task 228. For example, the processing layer 204 can determine which motors of the robotic vehicle 102 are to operate to move the robotic system 100 according to the assigned tasks 228. The motion planning also can be based on the location 224 of the robotic system 100, as determined from SLAM or another algorithm, and/or the model 220 of the environment surrounding the robotic system 100.

The processing layer 204 can determine designated movements 230 and use the designated movements 230 to determine control signals 232 that are communicated to the robotic vehicle 102 (“Motion Control” in FIG. 2). The control signals 232 can be communicated to the propulsion system 104 of the robotic vehicle 102 to direct how the motors or other components of the propulsion system 104 operate to move the robotic system 100 according to the assigned tasks 228.

In another aspect, the planning layer 206 can determine tasks to be performed by the manipulator arm 114 to perform maintenance on a vehicle. These tasks can include the distance, direction, and/or speed that the manipulator arm 114 is moved, the sequence of movements of the manipulator arm 114, the force imparted on the object-of-interest by the manipulator arm 114, and the like. The movements and/or sequence of movements determined by the planning layer 206 of the controller 106 may be referred to as arm tasks 234. The arm tasks 234 can dictate the order of different movements, the magnitude (e.g., distance) of the movements, the speed and/or acceleration involved in the movements, etc., of the manipulator arm 114. The arm tasks 234 can then be assigned to the manipulator arm 114 (or to individual motors of the arm 114 as the other “Task Assignment” in FIG. 2).

The planning layer 206 can communicate the arm tasks 234 and the different components that are to perform the tasks 234 to the processing layer 204 of the controller 106 as assigned arm tasks 236. The assigned tasks 236 can indicate the various tasks 234 as well as which component (e.g., the robotic vehicle 102 and/or the manipulator arm 114) is to perform the various tasks 234. The processing layer 204 receives the assigned arm tasks 236 and plans the movement of the manipulator arm 114 based on the assigned arm tasks 236 (“Task Planning And Coordination” in FIG. 2). This planning can include determining which component of the manipulator arm 114 is to perform an assigned arm task 236. For example, the processing layer 204 can determine which motors of the manipulator arm 114 are to operate to move the manipulator arm 114 according to the assigned arm tasks 236.

The processing layer 204 can determine planned arm movements 238 based on the assigned arm tasks 236. The planned arm movements 238 can include the sequence of movements of the arm 114 to move toward, grasp, move, and release one or more components of a vehicle, such as a brake lever. The processing layer 204 can determine movement trajectories 240 of the arm 114 based on the planned arm movements 238 (“Trajectory Planning” in FIG. 2). The trajectories 240 represent or indicate the paths that the arm 114 is to move along to complete the assigned arm tasks 236 using the planned arm movements 238.

The processing layer 204 of the controller 106 can determine the trajectories 240 of the arm 114 to safely and efficiently move the arm 114 toward the component (e.g., brake lever) to be actuated by the arm 114. The trajectories 240 that are determined can include one or more linear trajectories in joint space, one or more linear trajectories in Cartesian space, and/or one or more point-to-point trajectories in joint space.

When the arm 114 is moving in an open space for a long distance and far away from the vehicles and components (e.g., brake levers), the trajectories 240 may not be generated based on motion patterns of the arm 114. The starting position and target position of the motion of the arm 114 can be defined by the processing layer 204 based on the planned arm movements 238. Using an algorithm such as an artificial potential field algorithm, one or more waypoints for movement of the arm 114 can be determined. These waypoints can be located along lines in six degrees of freedom, but be located along non-linear lines in the Cartesian space. The processing layer 204 can assign velocities to each waypoint depending on the task requirements. One or more of the trajectories 240 can be these waypoints and velocities of movements of the arm 114.

Alternatively, if the positions of the components (e.g., brake levers) to be actuated by the arm 114 are defined as 6D poses in Cartesian space, the processing layer 204 of the controller 106 may convert the 6D pose estimation 222 to six joint angles in joint space using inverse kinematics. The processing layer 204 can then determine trajectories 240 for the arm 114 to move to these joint angles of the component from the current location and orientation of the arm 114.

Alternatively, the artificial potential field algorithm can be used to determine the waypoints for movement of the arm 114 on a desired motion trajectory in Cartesian space. Using inverse kinematics, corresponding waypoints in the joint space may be determined from the waypoints in Cartesian space. Velocities can then be assigned to these way points to provide the trajectories 240.

The trajectories 240 that are determined can be defined as one or more sequences of waypoints in the joint space. Each waypoint can include the information of multiple (e.g., seven) joint angles, timing stamps (e.g., the times at which the arm 114 is to be at the various waypoints), and velocities for moving between the waypoints. The joint angles, timing stamps, and velocities are put into a vector of points to define the trajectories 240. The processing layer 204 can use the trajectories 240 to determine control signals 242 that are communicated to the manipulator arm 114 (the other “Motion Control” in FIG. 2). The control signals 242 can be communicated to the motors or other moving components of the arm 114 to direct how the arm 114 is to move.

In one embodiment, the sensor 112 (shown in FIG. 1) may include a microswitch attached to the manipulator arm 114. Whenever the arm 114 or the distal end of the arm 114 engages a component of the vehicle or other object, the microswitch sensor 112 is triggered to provide a feedback signal 244. This feedback signal 244 is received (“Validation” in FIG. 2) by the processing layer 204 of the controller 106 from the sensor 112, and may be used by the processing layer 204 to determine the planned arm movements 238. For example, the processing layer 204 can determine how to move the arm 114 based on the tasks 236 to be performed by the arm 114 and the current location or engagement of the arm 114 with the component or vehicle (e.g., as determined from the feedback signal 244). The planning layer 206 may receive the feedback signal 244 and use the information in the feedback signal 244 to determine the arm tasks 234. For example, if the arm 114 is not yet engaged with the vehicle or component, then an arm task 236 created by the planning layer 206 may be to continue moving the arm 114 until the arm 114 engages the vehicle or component.

Once the arm 114 engages the component, the arm 114 may perform one or more operations. These operations can include, for example, moving the component to bleed air from brakes of the vehicle or other operations.

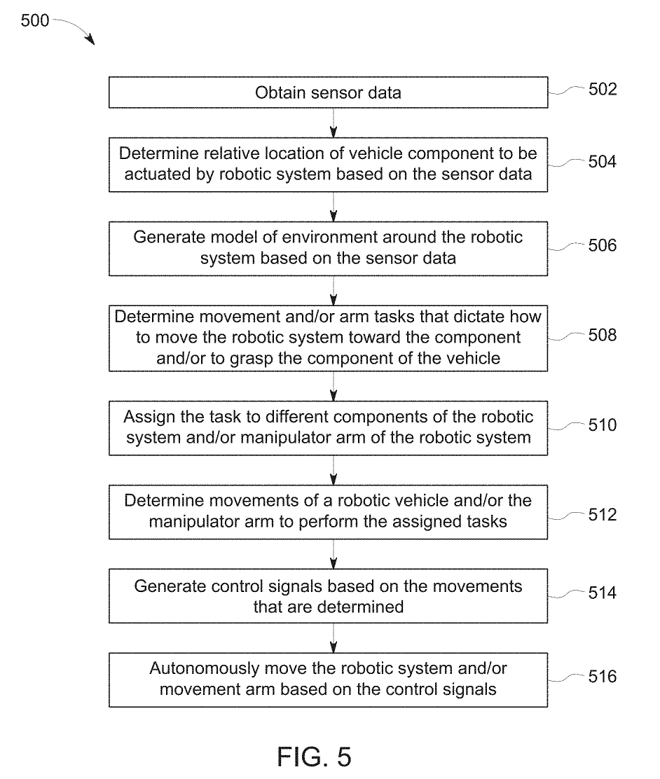

FIG. 5 illustrates a flowchart of one embodiment of a method 500 for autonomous control of a robotic system for vehicle maintenance. The method 500 may be performed to control movement of the robotic system 100 in performing vehicle maintenance, such as bleeding air brakes of a vehicle. In one embodiment, the various modules and layers of the controller 106 perform the operations described in connection with the method 500. At 502, sensor data is obtained from one or more sensors operably connected with the robotic system. For example, 2D image data, 3D image data, and/or detections of touch may be provided by the sensors 108-112.

At 504, the image data obtained from the sensor(s) is examined to determine a relative location of a component of a vehicle to be actuated by the robotic system. For example, the image data provided by the sensors 108-111 may be examined to determine the location of a brake lever relative to the robotic system 100, as well as the orientation (e.g., pose) of the brake lever. At 506, a model of the environment around the robotic system is generated based on the image data, as described above.

At 508, a determination is made as to how to control movement of the robotic system to move the robotic system toward a component of a vehicle to be actuated by the robotic system. This determination may involve examining the environmental model to determine how to safely and efficiently move the robotic system to a location where the robotic system can grasp and actuate the component. This determination can involve determining movement tasks and/or arm tasks to be performed and which components of the robotic system are to perform the tasks. The tasks can include the distance, direction, and/or speed that the robotic vehicle moves the robotic system and/or manipulator arm, the sequence of movements of the robotic vehicle and/or arm, and the like.

At 510, the movement and/or arm tasks determined at 508 are assigned to different components of the robotic system. The tasks may be assigned to the robotic vehicle, the manipulator arm, or components of the robotic vehicle and/or arm for performance by the corresponding vehicle, arm, or component.

At 512, the movements by the robotic vehicle and/or manipulator arm to perform the assigned tasks are determined. For example, the directions, distances, speeds, etc., that the robotic vehicle and/or arm need to move to be in positions to perform the assigned tasks are determined. At 514, control signals based on the movements determined at 512 are generated and communicated to the components of the robotic vehicle and/or arm. These control signals direct motors or other powered components of the vehicle and/or arm to operate in order to perform the assigned tasks. At 516, the robotic vehicle and/or manipulator arm autonomously move to actuate the component of the vehicle on which maintenance is to be performed by the robotic system.

In one embodiment, a robotic system includes a controller configured to obtain image data from one or more optical sensors and to determine one or more of a location and/or pose of a vehicle component based on the image data. The controller also is configured to determine a model of an external environment of the robotic system based on the image data and to determine tasks to be performed by components of the robotic system to perform maintenance on the vehicle component. The controller also is configured to assign the tasks to the components of the robotic system and to communicate control signals to the components of the robotic system to autonomously control the robotic system to perform the maintenance on the vehicle component.

The controller can be configured to obtain two dimensional (2D) and three dimensional (3D) image data from the one or more optical sensors as the image data. The controller can be configured to determine the model of the external environment as a grid-based representation of the external environment based on the image data. The controller optionally is configured to determine the tasks to be performed by a propulsion system that moves the robotic system and a manipulator arm configured to actuate the vehicle component.

In one example, the controller is configured to determine the tasks to be performed by the robotic system based on the model of the external environment and the one or more of the location or pose of the vehicle component. The controller can be configured to determine waypoints for a propulsion system of the robotic system to move the robotic system based on one or more of the tasks assigned to the propulsion system by the controller and on a mapping of a location of the robotic system in the model of the external environment determined by the controller.

Optionally, the controller is configured to receive a feedback signal from one or more touch sensors representative of contact between a manipulator arm of the robotic system and an external body to the robotic system, and to assign one or more of the tasks to the manipulator arm based also on the feedback signal. The controller can be configured to determine a movement trajectory of one or more of a propulsion system of the robotic system or a manipulator arm of the robotic system based on the tasks that are assigned and the model of the external environment.

In one example, the vehicle component of a brake lever of an air brake for a vehicle.

In one embodiment, a method includes obtaining image data from one or more optical sensors, determining one or more of a location or pose of a vehicle component based on the image data, determining a model of an external environment of the robotic system based on the image data, determining tasks to be performed by components of the robotic system to perform maintenance on the vehicle component, assigning the tasks to the components of the robotic system, and communicating control signals to the components of the robotic system to autonomously control the robotic system to perform the maintenance on the vehicle component.

The image data that is obtained can include two dimensional (2D) and three dimensional (3D) image data from the one or more optical sensors. The model of the external environment can be a grid-based representation of the external environment based on the image data. The tasks can be determined to be performed by a propulsion system that moves the robotic system and a manipulator arm configured to actuate the vehicle component.

Optionally, the tasks are determined based on the model of the external environment and the one or more of the location or pose of the vehicle component. The method also can include determining waypoints for a propulsion system of the robotic system to move the robotic system based on one or more of the tasks assigned to the propulsion system and on a mapping of a location of the robotic system in the model of the external environment. In one example, the method also includes receiving a feedback signal from one or more touch sensors representative of contact between a manipulator arm of the robotic system and an external body to the robotic system, where one or more of the tasks are assigned to the manipulator arm based on the feedback signal.

The method also may include determining a movement trajectory of one or more of a propulsion system of the robotic system or a manipulator arm of the robotic system based on the tasks that are assigned and the model of the external environment.

In one embodiment, a robotic system includes one or more optical sensors configured to generate image data representative of an external environment and a controller configured to obtain the image data and to determine one or more of a location or pose of a vehicle component based on the image data. The controller also can be configured to determine tasks to be performed by components of the robotic system to perform maintenance on the vehicle component and to assign the tasks to the components of the robotic system based on the image data and based on a model of the external environment. The controller can be configured to communicate control signals to the components of the robotic system to autonomously control the robotic system to perform the maintenance on the vehicle component.

Optionally, the controller also is configured to determine the model of an external environment of the robotic system based on the image data. The controller can be configured to determine waypoints for a propulsion system of the robotic system to move the robotic system based on one or more of the tasks assigned to the propulsion system by the controller and on a mapping of a location of the robotic system in the model of the external environment determined by the controller.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A robotic system comprising:
a controller configured to obtain image data from one or more optical sensors, the controller also configured to determine one or more of a location or pose of a vehicle component based on the image data and to determine a model of an external environment of the robotic system based on the image data, the controller also configured to determine tasks to be performed by components of the robotic system to perform maintenance on the vehicle component and to assign the tasks to the components of the robotic system, wherein the controller also is configured to communicate control signals to the components of the robotic system to autonomously control the robotic system to perform the maintenance on the vehicle component.

2. The robotic system of claim 1, wherein the controller is configured to obtain two dimensional (2D) and three dimensional (3D) image data from the one or more optical sensors as the image data.

3. The robotic system of claim 1, wherein the controller is configured to determine the model of the external environment as a grid-based representation of the external environment based on the image data.

4. The robotic system of claim 1, wherein the controller is configured to determine the tasks to be performed by a propulsion system that moves the robotic system and a manipulator arm configured to actuate the vehicle component.

5. The robotic system of claim 1, wherein the controller is configured to determine the tasks to be performed by the robotic system based on the model of the external environment and the one or more of the location or pose of the vehicle component.

6. The robotic system of claim 1, wherein the controller is configured to determine waypoints for a propulsion system of the robotic system to move the robotic system based on one or more of the tasks assigned to the propulsion system by the controller and on a mapping of a location of the robotic system in the model of the external environment determined by the controller.

7. The robotic system of claim 1, wherein the controller is configured to receive a feedback signal from one or more touch sensors representative of contact between a manipulator arm of the robotic system and an external body to the robotic system, the controller also configured to assign one or more of the tasks to the manipulator arm based also on the feedback signal.

8. The robotic system of claim 1, wherein the controller is configured to determine a movement trajectory of one or more of a propulsion system of the robotic system or a manipulator arm of the robotic system based on the tasks that are assigned and the model of the external environment.

9. The robotic system of claim 1, wherein the vehicle component of a brake lever of an air brake for a vehicle.

10. A method comprising:
obtaining image data from one or more optical sensors;
determining one or more of a location or pose of a vehicle component based on the image data;
determining a model of an external environment of the robotic system based on the image data;
determining tasks to be performed by components of the robotic system to perform maintenance on the vehicle component;
assigning the tasks to the components of the robotic system; and
communicating control signals to the components of the robotic system to autonomously control the robotic system to perform the maintenance on the vehicle component.

11. The method of claim 10, wherein the image data that is obtained includes two dimensional (2D) and three dimensional (3D) image data from the one or more optical sensors.

12. The method of claim 10, wherein the model of the external environment is a grid-based representation of the external environment based on the image data.

13. The method of claim 10, wherein the tasks are determined to be performed by a propulsion system that moves the robotic system and a manipulator arm configured to actuate the vehicle component.

14. The method of claim 10, wherein the tasks are determined based on the model of the external environment and the one or more of the location or pose of the vehicle component.

15. The method of claim 10, further comprising determining waypoints for a propulsion system of the robotic system to move the robotic system based on one or more of the tasks assigned to the propulsion system and on a mapping of a location of the robotic system in the model of the external environment.

16. The method of claim 10, further comprising receiving a feedback signal from one or more touch sensors representative of contact between a manipulator arm of the robotic system and an external body to the robotic system, wherein one or more of the tasks are assigned to the manipulator arm based on the feedback signal.

17. The method of claim 10, further comprising determining a movement trajectory of one or more of a propulsion system of the robotic system or a manipulator arm of the robotic system based on the tasks that are assigned and the model of the external environment.

18. A robotic system comprising:
one or more optical sensors configured to generate image data representative of an external environment; and
a controller configured to obtain the image data and to determine one or more of a location or pose of a vehicle component based on the image data, the controller also configured to determine tasks to be performed by components of the robotic system to perform maintenance on the vehicle component and to assign the tasks to the components of the robotic system based on the image data and based on a model of the external environment, wherein the controller also is configured to communicate control signals to the components of the robotic system to autonomously control the robotic system to perform the maintenance on the vehicle component.

19. The robotic system of claim 18, wherein the controller also is configured to determine the model of an external environment of the robotic system based on the image data.

20. The robotic system of claim 18, wherein the controller is configured to determine waypoints for a propulsion system of the robotic system to move the robotic system based on one or more of the tasks assigned to the propulsion system by the controller and on a mapping of a location of the robotic system in the model of the external environment determined by the controller.
